(19) United States
(12) Patent Application Publication
(10) Pub. No.: US 2022/0128143 A1
(43) Pub. Date: Apr. 28, 2022

(54) CONTINUOUSLY VARIABLE TRANSMISSION

(71) Applicant: WEIHAI TUANZHONG TRANSMISSION CO., LTD., WEIHAI (CN)

(72) Inventors: Yongfeng TANG, WEIHAI (CN); Yuning TANG, WEIHAI (CN)

(73) Assignee: WEIHAI TUANZHONG TRANSMISSION CO., LTD., WEIHAI (CN)

(21) Appl. No.: 17/430,580

(22) PCT Filed: Feb. 5, 2020
(86) PCT No.: PCT/CN2020/074338

§ 371 Date: Aug. 12, 2021

(30) Foreign Application Priority Data
Feb. 21, 2019 (CN) 201910140359.1

(51) Int. Cl. F16H 57/031; F16H 57/08; F16H 47/12

(52) U.S. Cl. CPC F16H 57/031; F16H 47/12; F16H 57/08

(57) ABSTRACT

A continuously variable transmission, being provided with a housing (3) and an inner cavity (4); a shaft (5) is provided as penetrating through the middle of a first end cover (301), the shaft (5) is rotatably connected to the first end cover (301), a sun gear (102) is fixedly provided on the shaft (5), the sun gear (102) is located inside the first end cover (301), a support frame (6) is provided adjacent to the sun gear (102), planet gears (101) are provided on the outer circumference of the sun gear (102), the planet gears (101) mesh with the sun gear (102), and the planet gears (101) and the sun gear (102) form a planet gear group (1); a planet gear shaft (7) is fixedly provided in the middle of each planet gear (101), the planet gear shafts (7) sequentially penetrate through the planet gears (101) and the support frame (6), a bucket wheel (201) is fixedly provided on each planet gear shaft (7) penetrating through the support frame (6), the bucket wheels (201) are located between the support frame (6) and a second end cover (303), the bucket wheels (201) fixedly provided on the plurality of planet gear shafts (7) form a bucket wheel group (2). The invention has a simple structure, low cost, reliable performance, and provides a continuously variable transmission suitable for normal operating conditions. The continuously variable transmission can be widely used in the field of transmissions.

### BACKGROUND OF THE INVENTION

### Field of the Invention

The present invention relates to a mechanical transmission apparatus, and in particularly to a continuously variable transmission.

### Description of the Related Art

An existing continuously variable transmission is provided with an outer housing, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a first shaft penetrates in the middle of the first end cover, the first shaft is rotatably connected to the first end cover, a first sun gear is fixedly provided on the first shaft, the first sun gear is located inside the first end cover, the first sun gear is adjacently provided with a first support frame, a first planet gear is provided on an outer circumference of the first sun gear, the first planet gear is engaged with the first sun gear, and the first planet gear and the first sun gear constitute a first planet gear set; a second shaft penetrates in the middle of the second end cover, the second shaft is rotatably connected to the second end cover, a second sun gear is fixedly provided on the second shaft, the second sun gear is located inside the second end cover, the second sun gear is adjacently provided with a second support frame, a second planet gear is provided on an outer circumference of the second sun gear, the second planet gear is engaged with the second sun gear, and the second planet gear and the second sun gear constitute a second planet gear set; the first planet gear and the second planet gear are fixedly connected by a planet gear shaft, the planet gear shaft penetrates through the first planet gear, the first support frame, the second support frame and the second planet gear in turn, the planet gear shaft is rotatably connected to the first support frame and the second support frame, a bucket wheel is fixedly provided on the planet gear shaft between the first support frame and the second support frame, and a plurality of bucket wheels fixedly provided on the planet gear shaft constitute a bucket wheel set.

Since this continuously variable transmission has two planet gear sets, the volume is larger, the structure is complicated, the manufacturing process is cumbersome, the cost is high, and the requirement for low cost in the simple power transmission field cannot be satisfied.

### SUMMARY OF THE INVENTION

The present invention is to solve the technical problem that an existing continuously variable transmission mainly uses an input shaft and an output shaft to transmit power, and generally, the volume is larger, the structure is complicated, the manufacturing process is cumbersome, the cost is high, and the requirement for low cost in the simple power transmission field cannot be satisfied. The present invention provides a continuously variable transmission with only one planet gear set, which has simple structure, low cost, reliable performance and is suitable for ordinary working condition requirement.

To this end, the technical solution of the present invention is a continuously variable transmission provided with an outer housing, wherein an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a shaft penetrates in the middle of the first end cover, the shaft is rotatably connected to the first end cover, a sun gear is fixedly provided on the shaft, the sun gear is located inside the first end cover, the sun gear is adjacently provided with a support frame, a planet gear is provided on an outer circumference of the sun gear, the planet gear is engaged with the sun gear, and the planet gear and the sun gear constitute a planet gear set; a planet gear shaft is fixedly provided in the middle of the planet gear, the planet gear shaft penetrates through the planet gear and the support frame in turn, the planet gear shaft is rotatably connected to the support frame, a bucket wheel is fixedly provided on the planet gear shaft passing through the support frame, the bucket wheel is located between the support frame and the second end cover, and the bucket wheels fixedly provided on a plurality of the planet gear shafts constitute a bucket wheel set.

Preferably, a semicircular cavity is provided in a position corresponding to the bucket wheel in an inner wall of the outer housing, and the bucket wheel is located in the semicircular cavity.

Preferably, there are 3 or more planet gears.

Preferably, a central bucket wheel is fixedly provided on the shaft.

A continuously variable transmission is provided with an outer housing, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a shaft penetrates in the middle of the first end cover, the shaft is rotatably connected to the first end cover, a gear ring is fixedly provided on the shaft, the gear ring is located inside the first end cover, the gear ring is adjacently provided with a support frame, a planet gear is provided inside an outer circumference of the gear ring, the planet gear is engaged with the gear ring, and the planet gear and the gear ring constitute a planet gear set; a planet gear shaft is fixedly provided in the middle of the planet gear, the planet gear shaft penetrates through the planet gear and the support frame in turn, the planet gear shaft is rotatably connected to the support frame, a bucket wheel is fixedly provided on the planet gear shaft passing through the support frame, the bucket wheel is located between the support frame and the second end cover, and the bucket wheels fixedly provided on a plurality of the planet gear shafts constitute a bucket wheel set.

Preferably, a semicircular cavity is provided in a position corresponding to the bucket wheel in an inner wall of the outer housing, and the bucket wheel is located in the semicircular cavity.

The benefit effects of the present invention are as follows. An outer housing is provided, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity; a shaft penetrates in the middle of the first end cover, the shaft is rotatably connected to the first end cover, a sun gear is fixedly provided on the shaft, the sun gear is located inside the first end cover, the sun gear is adjacently provided with a support frame, a planet gear is provided on an outer circumference of the sun gear, the planet gear is engaged with the sun gear, and the planet gear and the sun gear constitute a planet gear set; a planet gear shaft is fixedly provided in the middle of the planet gear, the planet gear shaft penetrates through the planet gear and the support frame in turn, a bucket wheel is fixedly provided on the planet gear shaft passing through the support frame, the bucket wheel is located between the support frame and the second end cover, and bucket wheels fixedly provided on the planet gear shafts constitute a bucket wheel set. This continuously variable transmission has only one planet gear set in terms of structure, has low cost and simple and reliable performance, and can achieve zero-speed start and fast start without external resistance when starting. This continuously variable transmission has flexible transmission process and synchronous rated working condition, can achieve self-adaptive adjustment without a control apparatus, can achieve automatch in a case of little change in torque and speed, and can be applied to high-power flexible transmission occasions.

### BRIEF DESCRIPTION OF THE DRAWINGS

FIG. 1 is an axonometric view of Embodiment 1 of the present invention;

FIG. 2 is a section view of FIG. 1;

FIG. 3 is a section view of FIG. 2;

FIG. 4 is a schematic view after removing an outer housing;

FIG. 5 is an axonometric view of Embodiment 2 of the present invention;

FIG. 6 is a section view of FIG. 5;

FIG. 7 is a section view of FIG. 6;

FIG. 8 is a schematic view after removing an outer housing.

Symbols in the drawings:

1. planet gear set; 101. planet gear; 102. sun gear; 102A. gear ring; 2. bucket wheel set; 201. bucket wheel; 3. outer housing; 301. first end cover; 302. intermediate housing; 303. second end cover; 4. inner cavity; 5. shaft; 6. support frame; 7. planet gear shaft; 8. central bucket wheel.

### DESCRIPTION OF THE EMBODIMENTS

The present invention will be further described below in conjunction with the embodiments.

### Embodiment 1

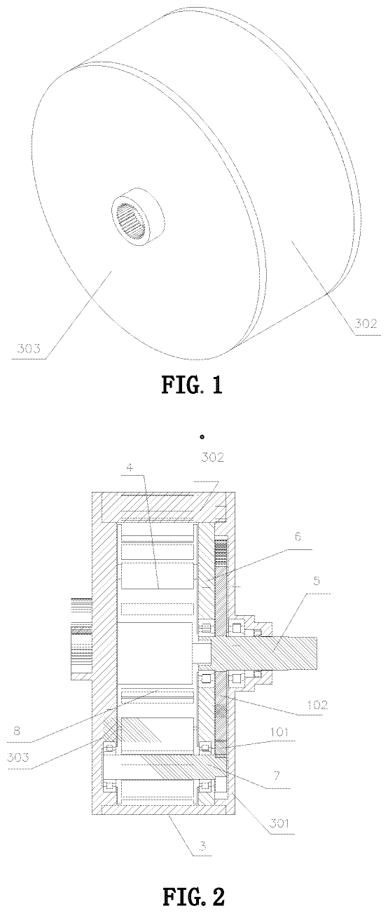

FIGS. 1-4 show an embodiment of a continuously variable transmission of the present invention. The continuously variable transmission is provided with an outer housing 3, an intermediate housing 302 is provided in the middle of the outer housing 3, a first end cover 301 and a second end cover 303 are respectively provided on both sides of the intermediate housing 302, the inside of the intermediate housing 302 is a cavity structure, and the cavity inside the intermediate housing 302 and insides of the first end cover 301 and the second end cover 303 form an inner cavity 4; a shaft 5 penetrates in the middle of the first end cover 301, the shaft 5 is rotatably connected to the first end cover 301, a sun gear 102 is fixedly provided on the shaft 5, the sun gear 102 is located inside the first end cover 301, the sun gear 102 is adjacently provided with a support frame 6, a planet gear 101 is provided on an outer circumference of the sun gear 102, the planet gear 101 is engaged with the sun gear 102, and the planet gear 101 and the sun gear 102 constitute a planet gear set 1; a planet gear shaft 7 is fixedly provided in the middle of the planet gear 101, the planet gear shaft 7 penetrates through the planet gear 101 and the support frame 6 in turn, the planet gear shaft 7 is rotatably connected to the support frame 6, a bucket wheel 201 is fixedly provided on the planet gear shaft 7 passing through the support frame 6, the bucket wheel 201 is located between the support frame 6 and the second end cover 303, and the bucket wheels 201 fixedly provided on a plurality of the planet gear shafts 7 constitute a bucket wheel set 2.

The operation process of the continuously variable transmission of this Embodiment 1 is as follows. The shaft 5 is used as a power input end, and the outer housing 3 is used as a power output end. When the continuously variable transmission starts, the outer housing 3 is used as the power output end, and remains stationary due to external resistance. When the input power is input clockwise from the shaft 5, the sun gear 102 is driven to rotate clockwise. Since the outer housing 3 remains stationary due to the external resistance, that is, the outer housing of the continuously variable transmission does not start to form a revolution action, the sun gear 102 drives the planet gear 101 to rotate counterclockwise, and drives the bucket wheel 201 to rotate counterclockwise through the fixedly connected planet gear shaft 7. The bucket wheel 201 is subjected to resistance of oil in the inner cavity 4 to form a torque, and this resistance includes hydrodynamic force due to oil injection from the bucket wheel 201 to the adjacent bucket wheel 201 and hydrodynamic viscous force of oil between the bucket wheel 201 and the intermediate housing 302. The resistance of oil to the bucket wheel 201 starts at 0, and increases exponentially as the speed of the shaft 5 increases, so that the outer housing 3 is driven to rotate through the support frame 6 and power is output through any part of the outer housing 3.

In the above process, the continuously variable transmission is in the zero-speed and zero-torque start state at the initial stage of starting. At the middle stage of starting of the continuously variable transmission, the resistance to the bucket wheel set 2 increases rapidly, and the resistance finally acts on the support frame 6 and also acts on the intermediate housing 302. The outer housing 3 forms a power output. Under the rated working condition of the continuously variable transmission, the speed and torque of the continuously variable transmission are relatively stable. Because of the force balance, the bucket wheel 201 will not rotate, and the mutual gears do not rotate. The synchronous transmission of power is achieved on the whole, which is close to 1:1 transmission.

This embodiment is suitable for occasions that require flexible start and long-term work. Since the start does not have hydrodynamic gravity provided by revolution, there is no load or light load when starting. After the continuously variable transmission operates, the hydrodynamic gravity plays a role, and together with hydrodynamic force and hydrodynamic viscous force, makes the range of transmitted torque increase. The overload of a normal range will not affect the flexibility and torque operation of the continuously variable transmission. It is especially suitable for devices that work throughout the year such as a belt conveyor. The performance of the continuously variable transmission under ordinary working condition is satisfied, and at the same time, the manufacturing process is simple and the cost is low.

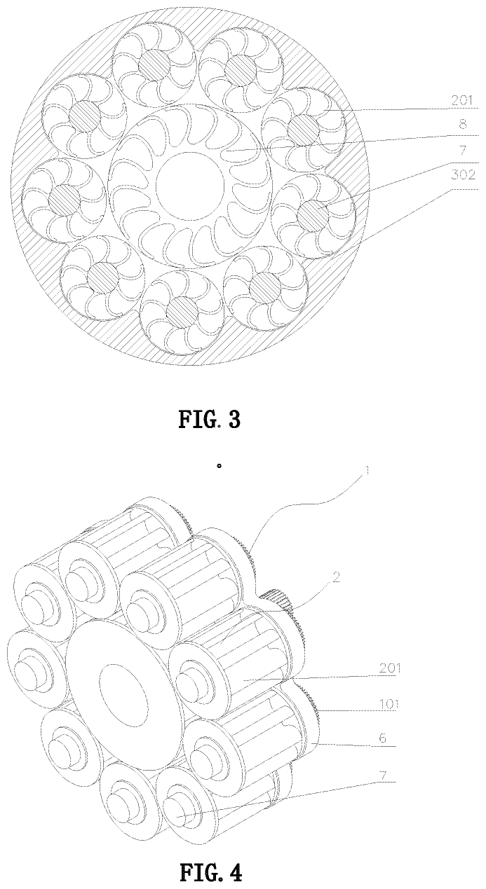

As can be seen in FIG. 3, a semicircular cavity is provided in a position corresponding to the bucket wheel 201 in an inner wall of the outer housing 3, and the bucket wheel 201 is located in the semicircular cavity. With such a structure, when the bucket wheel 201 rotates to operate, the hydrodynamic viscous force and the hydrodynamic force of the oil in the bucket wheel 201 and the inner cavity 4 can be fully transmitted. The hydrodynamic viscosity and hydrodynamic power, and the hydrodynamic viscous force and the hydrodynamic force will exert more effective performance. The compact optimization of volume is achieved and the better performance is satisfied, so that the continuously variable transmission outputs maximum power and torque.

This series of continuously variable transmission may adopt 3 or more planet gears 101. In this embodiment, there are 9 planet gears 101. Different numbers of planet gears 101 can be set according to transmitted power and used size, so as to adapt to different application requirements. Generally, different numbers can be selected, such as 6, 9, 12, and the like.

As can be seen in FIG. 3, a central bucket wheel 8 is fixedly provided on the shaft 5. Providing the central bucket wheel 8 can adjust the operation mode of the oil in the inner cavity 4 and adjust the operation performance.

According to the torque and power required to be transmitted, the external dimension of the continuously variable transmission can be adjusted, and different numbers of planet gears 101 can be set. After testing, when transmitting power of about 100 kw, the solution of 6 planet gears can be adopted, and the performance is more optimized.

### Embodiment 2

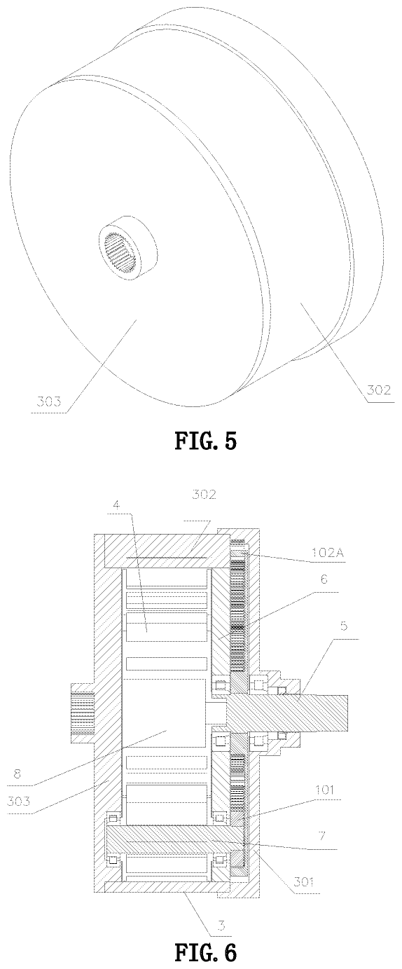

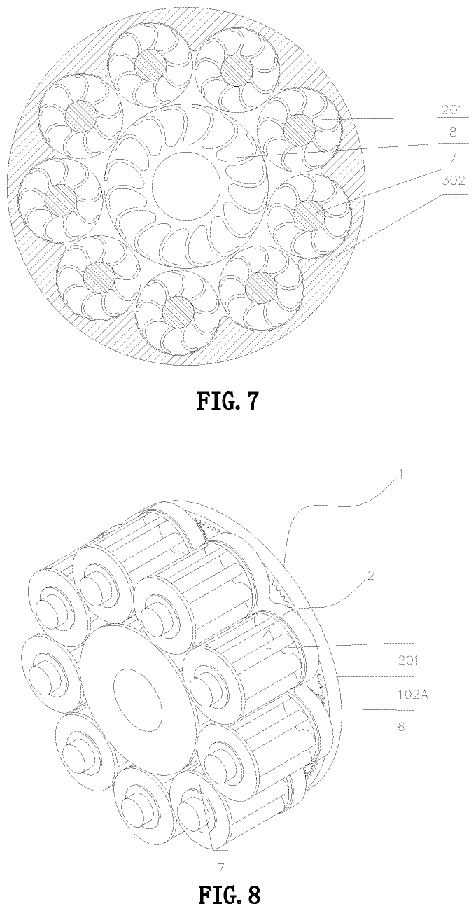

FIGS. 5-8 show another embodiment of a continuously variable transmission of the present invention. The continuously variable transmission is provided with an outer housing 3, an intermediate housing 302 is provided in the middle of the outer housing 3, a first end cover 301 and a second end cover 303 are respectively provided on both sides of the intermediate housing 302, the inside of the intermediate housing 302 is a cavity structure, and the cavity inside the intermediate housing 302 and insides of the first end cover 301 and the second end cover 303 form an inner cavity 4; a shaft 5 penetrates in the middle of the first end cover 301, the shaft 5 is rotatably connected to the first end cover 301, a gear ring 102A is fixedly provided on the shaft 5, the gear ring 102A is located inside the first end cover 301, the gear ring 102A is adjacently provided with a support frame 6, a planet gear 101 is provided inside an outer circumference of the gear ring 102A, the planet gear 101 is engaged with the gear ring 102A, and the planet gear 101 and the gear ring 102A constitute a planet gear set 1; a planet gear shaft 7 is fixedly provided in the middle of the planet gear 101, the planet gear shaft 7 penetrates through the planet gear 101 and the support frame 6 in turn, the planet gear shaft 7 is rotatably connected to the support frame 6, a bucket wheel 201 is fixedly provided on the planet gear shaft 7 passing through the support frame 6, the bucket wheel 201 is located between the support frame 6 and the second end cover 303, and the bucket wheels 201 fixedly provided on a plurality of the planet gear shafts 7 constitute a bucket wheel set 2.

As can be seen in FIG. 3, a semicircular cavity is provided in a position corresponding to the bucket wheel 201 in an inner wall of the outer housing 3, and the bucket wheel 201 is located in the semicircular cavity.

The differences between this embodiment and Embodiment 1 are in that, the sun gear 102 is replaced with the gear ring 102A, and the gear ring 102A transmits power to the planet gear 101. Since the gear ring 102A transmits torque with a radius much larger than that of the sun gear 102, the continuously variable transmission of this embodiment can transmit larger torque, and at the same time, the efficiency of engagement transmission between the gear ring 102A and the planet gear 101 is higher than that between the sun gear 102 and the planet gear 101.

After a comparative test, by comparing the technical solution of the gear ring 102A in this embodiment with that of the sun gear 102 in Embodiment 1, this embodiment increases the torque transmission capacity by about 40%, while reducing the damage of centrifugal force of the planet gear 101 during operation, and at the same time, the lubrication effect is better, and the working condition requirements of the continuously variable transmission in different application fields can be satisfied.

The above are only the specific embodiments of the present invention, and the scope of the present invention is not limited thereto, and thus all of the replacement of the equivalent components thereof, or the equivalent changes and modifications made according to the claimed scope of the present invention should still fall within the scope encompassed by the claims of the present invention.

1. A continuously variable transmission provided with an outer housing, characterized in that, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity;
a shaft penetrates in the middle of the first end cover, the shaft is rotatably connected to the first end cover, a sun gear is fixedly provided on the shaft, the sun gear is located inside the first end cover, the sun gear is adjacently provided with a support frame, a planet gear is provided on an outer circumference of the sun gear, the planet gear is engaged with the sun gear, and the planet gear and the sun gear constitute a planet gear set;
a planet gear shaft is fixedly provided in the middle of the planet gear, the planet gear shaft penetrates through the planet gear and the support frame in turn, the planet gear shaft is rotatably connected to the support frame, a bucket wheel is fixedly provided on the planet gear shaft passing through the support frame, the bucket wheel is located between the support frame and the second end cover, and the bucket wheels fixedly provided on a plurality of the planet gear shafts constitute a bucket wheel set.

2. The continuously variable transmission according to claim 1, characterized in that, a semicircular cavity is provided in a position corresponding to the bucket wheel in an inner wall of the outer housing, and the bucket wheel is located in the semicircular cavity.

3. The continuously variable transmission according to claim 1, characterized in that, there are 3 or more planet gears.

4. The continuously variable transmission according to claim 1, characterized in that, a central bucket wheel is fixedly provided on the shaft.

5. A continuously variable transmission provided with an outer housing, characterized in that, an intermediate housing is provided in the middle of the outer housing, a first end cover and a second end cover are respectively provided on both sides of the intermediate housing, the inside of the intermediate housing is a cavity structure, and the cavity inside the intermediate housing and insides of the first end cover and the second end cover form an inner cavity;
a shaft penetrates in the middle of the first end cover, the shaft is rotatably connected to the first end cover, a gear ring is fixedly provided on the shaft, the gear ring is located inside the first end cover, the gear ring is adjacently provided with a support frame, a planet gear is provided inside an outer circumference of the gear ring, the planet gear is engaged with the gear ring, and the planet gear and the gear ring constitute a planet gear set;
a planet gear shaft is fixedly provided in the middle of the planet gear, the planet gear shaft penetrates through the planet gear and the support frame in turn, the planet gear shaft is rotatably connected to the support frame, a bucket wheel is fixedly provided on the planet gear shaft passing through the support frame, the bucket wheel is located between the support frame and the second end cover, and the bucket wheels fixedly provided on a plurality of the planet gear shafts constitute a bucket wheel set.

6. The continuously variable transmission according to claim 5, characterized in that, a semicircular cavity is provided in a position corresponding to the bucket wheel in an inner wall of the outer housing, and the bucket wheel is located in the semicircular cavity.
